(19) United States
(12) Patent Application Publication
(10) Pub. No.: US 2012/0285745 A1
(43) Pub. Date: Nov. 15, 2012

(54) DRILLING FLUIDS

(75) Inventors: Philip Fletcher, Cambridgeshire (GB); Michael John Crabtree, Tyne and Wear (GB); Jeffrey Forsyth, Aberdeenshire (GB)

(73) Assignee: OILFLOW SOLUTIONS HOLDINGS LIMITED, Wigan, Lancashire (GB)

(21) Appl. No.: 13/522,567

(22) PCT Filed: Jan. 25, 2011
(86) PCT No.: PCT/GB2011/050115

§ 371 Date: Jul. 17, 2012

(30) Foreign Application Priority Data
Jan. 26, 2010 (GB) 1001229.2

(51) Int. Cl. C09K 8/04; E21B 7/18

(52) U.S. Cl. 175/65; 507/124

(57) ABSTRACT

An additive for a water-based mud drilling fluid or for drill-in fluids comprises a 0.5 wt % solution of 87-89 mole % hydrolysed polyvinylalcohol, having a weight average molecular weight of about 20,000. Use of the additive may reduce susceptibility of a wellbore to blockages, reduce accumulation of accretions between a drill string and wellbore casing, reduce bit-balling and facilitate separation of undesirable insoluble solids from a drilling fluid returned to the surface.

This invention relates to drilling fluids and particularly, although not exclusively, relates to drilling fluids for use in the drilling of wells in subterranean formations for the recovery of oil, for example medium and relatively heavy oils, including bitumens.

Hydrocarbons (crude oil or natural gas) are recovered from boreholes (wells) drilled deep into the earth. Conventionally, a borehole is drilled using a rotary drill bit on the end of a rotatable, hollow, drill pipe.

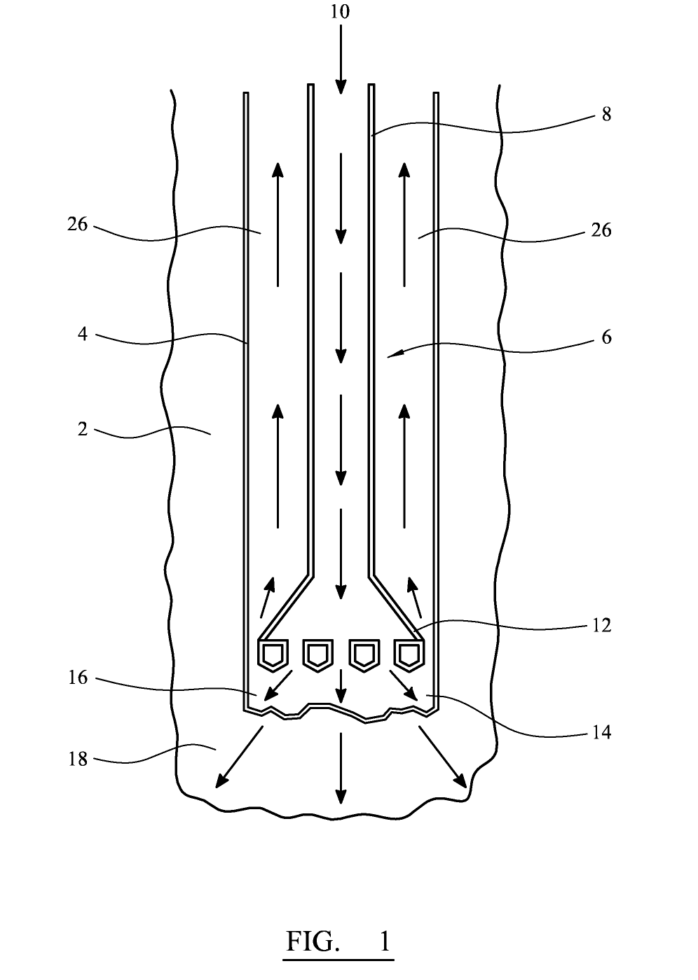

Drilling fluid is a complex mixture of liquids, solids and chemicals that must be formulated to provide the specific physical and chemical characteristics required to safely drill a well. Particular functions of the drilling fluid include cooling and lubricating a drill bit, lifting rock cuttings to the surface, preventing the destabilization of the rock at the wellbore walls and applying a hydrostatic pressure at the bit to overcome the pressure of fluids inside the rock so that these fluids do not enter the wellbore and progress to the surface uncontrollably. A proportion of the drilling fluid is always lost to the formation. Much of this fluid loss occurs at the moment that the drill bit hits new rock—this is called spurt loss. The outcome of fluid loss is that a region of near-wellbore reservoir is invaded with drilling fluid. This region may extend up to 12 inches into the reservoir. Consequently, the fluid used for a particular job is selected to avoid formation damage—that is, an alteration to the characteristics of the producing formation which reduces the ability of the formation to produce naturally-occurring fluids. Spurt loss is illustrated in FIG. 1 which is a schematic representation of a wellbore being drilled. There is shown an invaded zone 2 of a subterranean formation penetrated by a drilled wellbore 4. A drill 6 comprises a drill string 8 through which drilling fluid 10 passes towards a drill bit 12. When the drill bit 12 contacts rock 14 drilling fluid may spurt from the drill as illustrated by arrows 16 and penetrate the formation as illustrated by arrows 18.

In many situations, drilling fluids are formulated to reduce spurt loss and/or penetration of drilling fluid into the near wellbore. For example, the fluids may be relatively viscous and immobile so they tend not to penetrate very far into the wellbore. However, disadvantageously, any penetration into the wellbore can have the effect of blocking regions of the wellbore and may therefore restrict passage of oil from an oil reservoir into the wellbore. It is an object of one embodiment of the present invention to address this problem.

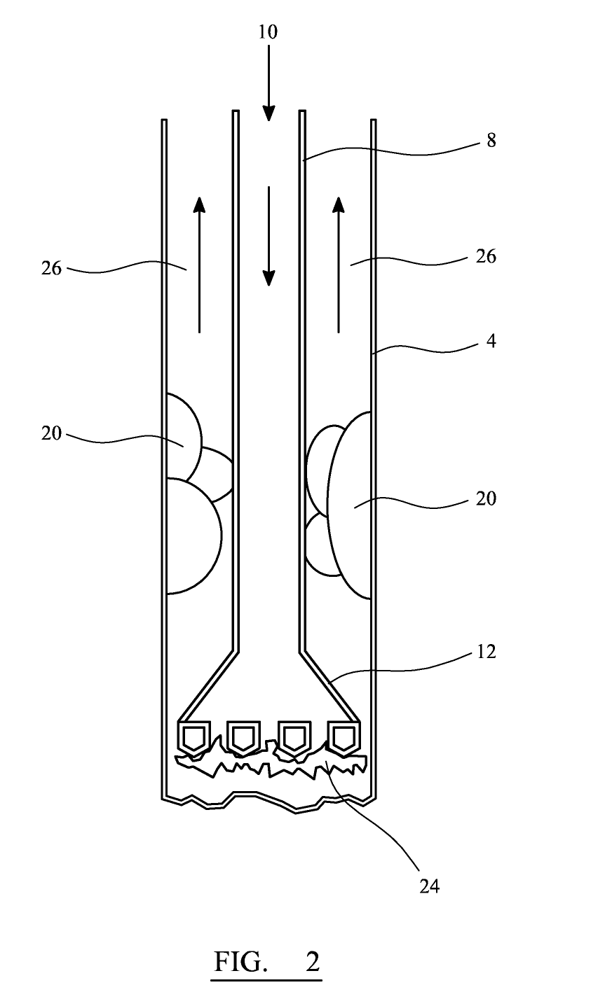

During the drilling of a wellbore, in particular those drilled to produce heavy oils and tar sands, solid drilled materials may aggregate in one or more parts of the wellbore or around other drill components such as drill-strings and Bottom Hole Assemblies (BHAs). These solid materials may be composed of drilled formation material mixed intimately with hydrocarbons, including bitumen. The solid materials may be contaminated with drilling fluid components such as clays or polymers. Due to their surface chemistries and high viscosities, heavy oils and tar sands in particular accrete (or stick) to surfaces. Accretion generally leads to localized blockages in the borehole, which impair the drilling process by increasing the drag on the drill string. It may occur to such an extent that the entire drill string can become stuck. Remediating such problems invariably results in the halting of drilling operations, a decrease in drilling rates and an increase in costs. FIG. 2 which is a schematic representation of a wellbore illustrates accretions 20 accumulating between a drill string and a wellbore 4. It is an object of one embodiment of the present invention to address this problem.

Water-based drilling fluids generally have a clay content, which is derived from those clays added as part of the formulation or from those occurring naturally in the drilled rock. The water in the drilling fluid is able to modify the colloidal characteristics of the clays, which causes them to swell, aggregate and adhere to downhole surfaces, commonly the drill bit itself. The adherence of clays, and other ‘sticky’ solids, to the cutting face of drill bits is known to impair their cutting ability. Such bits often slip over rock surfaces rather than drilling into them—a phenomenon known as bit-balling. FIG. 2 illustrates bit-balling 24 associated with drill bit 12. From an operational standpoint, bit-balling leads to increased pump pressures and reduced rates of penetration into the subterranean formation. It is an object of one embodiment of the present invention to address this problem.

Rock cuttings generated in the drilling operation are swept up by drilling fluid as it circulates back (illustrated by arrows 26 in FIGS. 1 and 2) to the surface outside the drill string 8. To achieve this carrying ability the viscosity of the drilling fluid must be regulated and be above a specified threshold. Once at surface the fluid, laden with solid cuttings, is directed through vibrating screens known as ‘shale shakers’, which separate the cuttings from the fluid. Once separated, the fluid is returned to a ‘mud pit’ to be adjusted back to its original specification prior to re-use. The separation process is assisted with centrifuges and hydrocyclones. The solids are thought of as agglomerations that may be rich in clays or, in some instances, contain hydrocarbons. They may adhere to the surfaces and internals of surface handling equipment and shale shakers, causing blockages and restriction to fluid flow that reduce the effectiveness of such equipment. This in turn leads to disadvantages such as reduced throughput, an increase in the number of remediation interventions and ultimately to increased cost. It is an object of one embodiment of the present invention to address this problem.

Liners are metal, plastic or ceramic tubes placed into a wellbore during or after it has been drilled. They include wellbore casing, slotted liners, wire wrap screens, mesh screens, gravel packs, tubing, including coiled or jointed tubing. When drilling horizontal bores, liners are put in place whilst the drilling fluid is still in the horizontal section and, in principle, the resistance experienced during placement is derived from the drilling fluid. However, there are situations where operators experience high resistive forces when inserting or withdrawing liners. This occurs because the drilled boreholes may not be completely free of oil-ladened sand. This oily sand (wellbore debris) may be more difficult to penetrate than the drilling fluid. The problem will be made worse if the liner in the borehole is eccentric and has to be placed through oily sand that has collected at the bottom of the horizontal wellbore by the action of gravity. Additionally, an eccentric liner may experience friction from its direct contact with the wellbore—this is another source of resistance to placement. It is an object of one embodiment of the present invention to address this problem.

According to a first aspect of the present invention, there is provided a method of drilling a bore hole in a subterranean formation, the method comprising the step of contacting a drill bit used in the drilling with a drilling fluid comprising a first polymeric material which includes —O— moieties pendent from a polymeric backbone.

During the drilling process, aqueous liquid comprising said first polymeric material may leak off (e.g. as a result of spurt loss or otherwise) into the subterranean formation. Whilst in many conventional drilling fluids steps are taken to reduce leak off, with the present fluid, leak off is not reduced; however, the fluid leaked off is not potentially detrimental (but is advantageous) to the formation and/or to the passage of hydrocarbons into the bore hole. Accordingly, use of said drilling fluid can facilitate oil production. In addition, inclusion of said first polymeric material in fluid circulating back to the surface can reduce accretions (particularly in the case of bores drilled to produce heavy oils or tar sands) accumulating between the drill string and wellbore and therefore reduce the risk of blockages which could impair the drilling process and be costly. Additionally, inclusion of said first polymeric material may reduce bit-balling by modifying the characteristics of insoluble solids in the drilling fluid and minimize their adherence to the cutting surfaces of the drill bit. Finally, inclusion of said first polymeric material can improve the efficiency of surface separation of solid drill cuttings from other fluids.

Said first polymeric material is preferably soluble in water at 25° C. Preferably, said drilling fluid comprises a solution of said first polymeric material.

Said polymeric backbone of said first polymeric material preferably includes carbon atoms. Said carbon atoms are preferably part of —CH₂— moieties. Preferably, a repeat unit of said polymeric backbone includes carbon to carbon bonds, preferably C—C single bonds. Preferably, said first polymeric material includes a repeat unit which includes a —CH₂— moiety. Preferably, said polymeric backbone does not include any —O— moieties, for example —C—O— moieties such as are found in an alkyleneoxy polymer, such as polyethyleneglycol. Said polymeric backbone is preferably not defined by an aromatic moiety such as a phenyl moiety such as is found in polyethersulphones. Said polymeric backbone preferably does not include any —S— moieties. Said polymeric backbone preferably does not include any nitrogen atoms. Said polymeric backbone preferably consists essentially of carbon atoms, preferably in the form of C—C single bonds.

Said —O— moieties are preferably directly bonded to the polymeric backbone.

Said first polymeric material preferably includes, on average, at least 10, more preferably at least 50, —O— moieties pendent from the polymeric backbone thereof. Said —O— moieties are preferably a part of a repeat unit of said first polymeric material.

Preferably, said —O— moieties are directly bonded to a carbon atom in said polymeric backbone of said first polymeric material, suitably so that said first polymeric material includes a moiety (which is preferably part of a repeat unit) of formula:

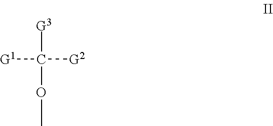

where G¹ and G² are other parts of the polymeric backbone and G³ is another moiety pendent from the polymeric backbone. Preferably, G³ represents a hydrogen atom.

Preferably, said first polymeric material includes a moiety

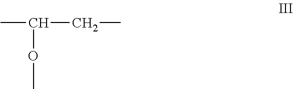

Said moiety III is preferably part of a repeat unit. Said moiety III may be part of a copolymer which includes a repeat unit which includes a moiety of a different type compared to moiety III. Suitably, at least 60 mole %, preferably at least 80 mole %, more preferably at least 90 mole %, especially at least 95 mole % of said first polymeric material comprises repeat units which comprise (preferably consist of) moieties III. Preferably, said first polymeric material consists essentially of repeat units which comprise (preferably consist of) moieties III.

Suitably, 60 mole %, preferably 80 mole %, more preferably 90 mole %, especially substantially all of said first polymeric material comprises vinyl moieties.

Preferably, the free bond to the oxygen atom in the —O— moiety pendent from the polymeric backbone of said first polymeric material (and preferably also in moieties II and III) is bonded to a group R¹⁰ (so that the moiety pendent from the polymeric backbone of said first polymeric material is of formula —O—R¹⁰). Preferably group R¹⁰ comprises fewer than 10, more preferably fewer than 5, especially 3 or fewer carbon atoms. It preferably only includes atoms selected from carbon, hydrogen and oxygen atoms. R¹⁰ is preferably selected from a hydrogen atom and an alkylcarbonyl, especially a methylcarbonyl group. Preferably moiety —O—R¹⁰ in said first polymeric material is an hydroxyl or acetate group.

Said first polymeric material may include a plurality, preferably a multiplicity, of functional groups (which incorporate the —O— moieties described) suitably selected from hydroxyl and acetate groups. Said polymeric material preferably includes at least some groups wherein R¹⁰ represents an hydroxyl group. Suitably, at least 30%, preferably at least 50%, especially at least 80% of groups R¹⁰ are hydroxyl groups. Said first polymeric material preferably includes a multiplicity of hydroxyl groups pendent from said polymeric backbone; and also includes a multiplicity of acetate groups pendent from the polymeric backbone.

The ratio of the number of acetate groups to the number of hydroxyl groups in said first polymeric material is suitably in the range 0 to 3, is preferably in the range 0.05 to 1, is more preferably in the range 0.06 to 0.3, is especially in the range 0.06 to 0.25.

Suitably at least 70%, preferably at least 80%, more preferably at least 90%, especially substantially each free bond to the oxygen atoms in —O— moieties pendent from the polymeric backbone in said first polymeric material is/are of formula —O—R¹⁰ wherein each group —OR¹⁰ is selected from hydroxyl and acetate.

Preferably, said first polymeric material includes a vinyl alcohol moiety, especially a vinyl alcohol moiety which repeats along the backbone of the polymeric material. Said first polymeric material preferably includes a vinyl acetate moiety, especially a vinylacetate moiety which repeats along the backbone of the polymeric material.

Said polymeric material suitably comprises at least 50 mole %, preferably at least 60 mole %, more preferably at least 70 mole %, especially at least 80 mole % of vinylalcohol repeat units. It may comprise less than 99 mole %, suitably less than 95 mole %, preferably 92 mole % or less of vinylalcohol repeat units. Said polymeric material suitably comprises 60 to 99 mole %, preferably 80 to 95 mole %, more preferably 85 to 95 mole %, especially 80 to 91 mole % of vinylalcohol repeat units.

Said first polymeric material preferably includes vinylacetate repeat units. It may include at least 2 mole %, preferably at least 5 mole %, more preferably at least 7 mole %, especially at least 9 mole % of vinylacetate repeat units. It may comprise 30 mole % or less, or 20 mole % or less of vinylacetate repeat units. Said polymeric material preferably comprises 9 to 20 mole % of vinylacetate repeat units.

Said first polymeric material is preferably not cross-linked.

Suitably, the sum of the mole % of vinylalcohol and vinylacetate repeat units in said first polymeric material is at least 80 mole %, preferably at least 90 mole %, more preferably at least 95 mole %, especially at least 99 mole %.

Said first polymeric material preferably comprises 70-95 mole %, more preferably 80 to 95 mole %, especially 85 to 91 mole % hydrolysed polyvinylalcohol.

The weight average molecular weight (Mw) of said first polymeric material may be less than 500,000, suitably less than 300,000, preferably less than 200,000, more preferably less than 100,000. In an especially preferred embodiment, the weight average molecular weight may be in the range 5,000 to 50,000. The weight average molecular weight of said polymeric material (Mw) may be less than 40,000, suitably is less than 30,000, preferably is less than 25,000. The Mw may be at least 5,000, preferably at least 10,000. The Mw is preferably in the range 5,000 to 25,000, more preferably in the range 10,000 to 25,000.

The viscosity of a 4 wt % aqueous solution of the first polymeric material at 20° C. is preferably in the range 1.5-7 cP.

The viscosity of a said 4 wt % aqueous solution of the first polymeric material at 20° C. may be at least 2.0 cP, preferably at least 2.5 cP. The viscosity may be less than 6 cP, preferably less than 5 cP, more preferably less than 4 cP. The viscosity is preferably in the range 2 to 4 cP.

The number average molecular weight (Mₙ) of said first polymeric material may be at least 5,000, preferably at least 10,000, more preferably at least 13,000. Mₙ may be less than 40,000, preferably less than 30,000, more preferably less than 25,000. The Mₙ is preferably in the range 5,000 to 25,000.

Weight average molecular weight may be measured by light scattering, small angle neutron scattering, x-ray scattering or sedimentation velocity. The viscosity of the specified aqueous solution of the first polymeric material may be assessed by Japanese Standards Association (JSA) JIS K6726 using a Type B viscometer. Alternatively, viscosity may be measured using other standard methods. For example, any laboratory rotational viscometer may be used such as an Anton Paar MCR300.

The method of the first aspect may include a step prior to the step of contacting said drill bit with drilling fluid of selecting said first polymeric material. Said first polymeric material may be contacted with a precursor of said drilling fluid thereby to prepare said drilling fluid. Said precursor of said drilling fluid may be a drilling fluid in its own right (e.g. a conventional drilling fluid) and such drilling fluid may be modified to prepare the drilling fluid for use in the method by mixing it with said first polymeric material.

Said first polymeric material selected may comprise a solid, for example a powder, which may be contacted with said precursor of said drilling fluid. In a less preferred embodiment, an aqueous formulation comprising said first polymeric material may be contacted with said precursor of said drilling fluid.

Said drilling fluid suitably includes at least 0.1 wt %, preferably at least 0.2 wt %, more preferably at least 0.3 wt % of said first polymeric material. It may include less than 1.5 wt % preferably less than 1 wt %, more preferably less than 0.8 wt % of said first polymeric material. Said drilling fluid suitably includes 0.1 to 1 wt % of said first polymeric material.

In a preferred embodiment, said drilling fluid comprises 0.1 to 1 wt % of said first polymeric material which is not cross-linked and said first polymeric material comprises 85 to 91 mole % hydrolyzed polyvinylalcohol having a Mw in the range 5,000 to 30,000 and/or wherein the viscosity of a 4 wt % aqueous solution of the polymeric material at 20° C., suitably measured as described herein, is in the range 1.5 to 6 cP.

In an especially preferred embodiment, said drilling fluid comprises 0.2 to 1 wt % of said first polymeric material which is not cross-linked and said first polymeric material comprises 85 to 91 mole % hydrolyzed polyvinylalcohol having a Mw in the range 10,000 to 30,000 and/or wherein the viscosity of a 4 wt % aqueous solution of the polymeric material at 20° C., suitably measured as described herein, is in the range 2 to 4 cP.

Said drilling fluid preferably does not include any component which is capable of cross-linking the first polymeric material, for example polyvinylalcohol.

Preferably, after contact between said first polymeric material and said precursor of said drilling fluid the viscosity of the drilling fluid rises by no more than 3 cP when measured at 25° C. and 100ₛ⁻¹.

Said drilling fluid of said first aspect preferably includes water. The ratio of the wt % of first polymeric material to the wt % of water in the drilling fluid is suitably at least 0.001, preferably at least 0.002, more preferably at least 0.003. The ratio may be less than 0.03, preferably less than 0.02. Preferably, said ratio is in the range 0.002 to 0.020, more preferably in the range 0.003 to 0.015.

Said drilling fluid suitably includes at least 30 wt %, preferably at least 40 wt % water. It may include at least 50 wt %, at least 60 wt % or at least 70 wt % water. The drilling fluid may include less than 95 wt %, preferably less than 90 wt %, more preferably less than 85 wt % water.

Said drilling fluid may include dispersed solids which are insoluble in the drilling fluid continuous phase (i.e. water). Such dispersed solids may be relatively high density finely divided solid material used to increase the density of the drilling fluid. Examples of dispersed solids include barites, barium sulphate, iron oxide (e.g. haematite), galena (PbS), calcium carbonate, siderite, ferrous carbonate, ilmentite, mixed iron oxide titanium dioxide. Said drilling fluid may include 1 to 70 wt %, suitably 2 to 50 wt %, preferably 5 to 30 wt %, more preferably 10 to 20 wt % of dispersed solids.

Said drilling fluid may include a lubricant formulation, suitably 0.5 to 10 wt %, preferably 1 to 5 wt % of said lubricant formulation.

Said drilling fluid may optionally include fluid loss control agents, shale inhibitors, rheology modifiers or viscosifiers, gas hydrate inhibitors and dispersants, the latter being to aid dispersion of solids within the drilling fluid. Dispersants may be present at 0.1 to 5 wt % in the drilling fluid.

Preferably, said drilling fluid of said first aspect includes at least 50 wt % water, and a said first polymeric material which comprises 85 to 91 mole % hydrolyzed polyvinylalcohol having a Mw in the range 5,000 to 30,000 and/or wherein the viscosity of a 4 wt % aqueous solution of the polymeric material at 20° C., suitably measured as described herein, is in the range 1.5 to 6 cP, wherein the ratio of the wt % of first polymeric material to the wt % of water in the drilling fluid is at least 0.002 and less than 0.02. Said drilling fluid preferably includes 0.1 to 1 wt % of said first polymeric material.

More preferably, said drilling fluid of said first aspect includes at least 60 wt % water, and a said first polymeric material which comprises 85 to 91 mole % hydrolyzed polyvinylalcohol having a Mw in the range 5,000 to 30,000 and/or wherein the viscosity of a 4 wt % aqueous solution of the polymeric material at 20° C., suitably measured as described herein, is in the range 1.5 to 6 cP, wherein the ratio of the wt % of first polymeric material to the wt % of water in the drilling fluid is at least 0.003 and less than 0.015. Said drilling fluid preferably includes 0.1 to 1 wt % of said first polymeric material.

The drilling fluid preferably includes less than 10 wt %, preferably less than 5 wt %, more preferably less than 3 wt %, especially 1 wt % or less of hydrocarbons, for example diesel oil as is included in an oil-based mud (OBM). Said drilling fluid is preferably not an oil-based mud.

Water for use in the treatment fluid may be derived from any convenient source. It may be potable water, surface water, sea water, aquifer water, deionised production water and filtered water derived from any of the aforementioned sources. Said water is preferably a brine, for example sea water or is derived from a brine such as sea water. The references to the amounts of water herein suitably refer to water exclusive of its components, e.g. naturally occurring components such as found in sea water.

When water is used (e.g. sea water) which includes naturally occurring components, the drilling fluid will include such components, suitably at a level of 5 wt % or less, 4 wt % or less or 3 wt % or less.

Said drilling fluid is preferably thixotropic.

The reference to a drilling fluid encompasses drill-in fluids which are fluids specifically designed for drilling through reservoir section of a wellbore. A drill-in fluid may be simpler than a drilling fluid which is used to drill upstream of a reservoir section of a wellbore. A drill-in fluid is designed for drilling through the reservoir section of a wellbore, to minimize damage and maximize production from exposed zones. A drill-in fluid may comprise said first polymeric material as described, a water-based brine and solids (e.g. salt crystals, calcium carbonate and/or polymers) of appropriate particle sizes. Only additives essential for filtration control and cuttings carrying are preferably included in a drill-in fluid.

The method of the first aspect suitably comprises injecting drilling fluid into the bore hole. It is suitably injected into a passage in a drill string. It suitably exits the passage of a drill bit, suitably through openings in the drill bit. Drilling fluid is suitably arranged to circulate down the drill string and then is arranged to flow upwardly, suitably so that it passes above the surface of the ground in which the bore hole is being drilled. At the surface, the drilling fluid is suitably treated to separate undesirable materials from the drilling fluid so that the drilling fluid may be reused. The drilling fluid which passes back to the surface (e.g. when isolated and at the surface) suitably comprises unsubstituted first polymeric material of the type described, preferably unsubstituted polyvinylalcohol. Thus, it is preferred that covalent bonds are not substantially made or broken in the first polymeric material during its passage from the surface and back to the surface via said drill bit. For example, in the preferred embodiment, drilling fluid does not cross-link during its passage from the surface and back to the surface via said drill bit.

The ratio of the concentration of first polymeric material injected into the bore hole to the concentration in fluid returned to the surface may be greater than 1, greater than 1.1, 1.2, 1.3 or 1.5. Said ratio may be less that 5, 4, 3 or 2.

The method may be particularly advantageous when oil to be extracted from said subterranean formation via said bore hole is other than a conventional light oil. For example, it may be a heavy oil. Heavy oils may be more susceptible to having their flow restricted by conventional drilling fluids which may enter a near wellbore region during spurt loss or otherwise cause blockages in the wellbore. Similarly, heavier oils may be more susceptible to accretion problems as discussed in the introduction of the present specification. Thus, in a preferred embodiment, said method comprises drilling a bore hole which penetrates an oil reservoir which comprise a crude oil which term in the context of the present specification includes tar (heavy crude oil), obtained from tar sands, and bitumen. The oil may have an API gravity of less than 45°, suitably less than 30°, preferably less than 25°, more preferably less than 20°. In some cases, the API gravity may be less than 15° or even less than 10°. In a preferred embodiment hydrocarbons may have a specific gravity in the range 0.8 to 1.03, for example in the range 0.92-1.03 and the API gravity is in the range 6 to 22.

The method may be particularly advantageous when deviated or especially horizontal wells are being drilled. Many heavy oil wells employ horizontal drilling and the invention described may be particularly relevant in such situations. Thus, the method of the first aspect preferably comprises drilling a deviated or, especially, a horizontal well, for example a horizontal well for use in Steam Assisted Gravity Drain (SAGD) process. The method may be especially advantageous when the crude oil in a reservoir penetrated by the bore hole has an API gravity of less than 30° (e.g. in the range 6 to 22°) and when the bore hole being drilled is a deviated or especially a horizontal well.

Whilst the method may be used in relation to low or high permeability reservoirs, it may be particularly beneficial for low permeability reservoirs, wherein there is a higher chance that spurt loss of conventional drilling fluids may block the reservoir. Thus, the method may be particularly beneficial for reservoirs with permeabilities in the range 0.5-10 Darcy, for example 1-5 Darcy. The method may advantageously be applied to reservoirs with the aforementioned permeabilities which comprise heavy oil, for example having an API gravity of less than 30° C., for example 6 to 22°.

The method preferably comprises substantially continuously injecting the drilling fluid when the bore hole is being drilled.

According to a second aspect of the invention, there is provided a method of preparing a drilling fluid as described according to the first aspect, the method comprising selecting a first polymeric material according to said first aspect, and contacting said first polymeric material with a precursor of said drilling fluid thereby to prepare said drilling fluid.

Said method of the second aspect may include any feature of the method of the first aspect mutatis mutandis.

According to a third aspect, there is provided a drilling fluid prepared in a method of the second aspect and/or as described according to the first aspect per se.

According to a fourth aspect, there is provided a method of preparing a pre-used drilling fluid for re-use, the method comprising:
(a) selecting a pre-used drilling fluid which has already been used in drilling a bore (for example in a method of the first aspect), wherein said pre-used fluid includes a first polymeric material as described according to the first aspect;
(b) separating undesirable components from the pre-used drilling fluid to provide a cleaned drilling fluid;
(c) contacting the cleaned drilling fluid with said first polymeric material to increase the concentration of said first polymeric material in said cleaned drilling fluid in order to prepare a cleaned drilling fluid for re-use.

According to a fifth aspect, there is provided a method of reducing the susceptibility of a well bore to blockages caused by penetration of components of drilling fluid thereinto during drilling, the method comprising the step of contacting a drill bit used in the drilling with a drilling fluid comprising a first polymeric method as described according to the first aspect.

In a sixth aspect, the invention provides the use of a first polymeric material as described according to the first aspect for reducing the susceptibility of a well bore to blockages caused by penetration of components of drilling fluid thereinto during drilling.

According to a seventh aspect, there is provided a method of reducing accumulation of accretions in a passage (e.g. defined between a drill string and wellbore casing) via which used drilling fluid is returned to the surface during drilling of a bore, the method comprising using a drilling fluid comprising a first polymeric material as described according to the first aspect in drilling the wellbore.

In an eighth aspect, the invention provides the use of a first polymeric material as descried according to the first aspect for reducing accumulation of accretions in a passage via which used drilling fluid is returned to the surface during drilling of a bore.

According to a ninth aspect, there is provided a method of reducing bit-balling associated with a drill bit during drilling of a bore, the method comprising using a drilling fluid comprising a first polymeric material as described according to the first aspect in drilling the wellbore.

In a tenth aspect, the invention provides the use of a first polymeric material according to the first aspect for reducing bit-balling associated with a drill bit during drilling of a bore.

According to an eleventh aspect, there is provided a method of facilitating separation of undesirable insoluble solids from a drilling fluid returned to the surface, the method comprising using a drilling fluid comprising a first polymeric material as described according to the first aspect in drilling the wellbore.

In a twelfth aspect, the invention provides the use of a first polymeric material according to the first aspect for facilitating separation of undesirable insoluble solids from a drilling fluid returned to the surface.

Any aspect of any invention described herein may be combined with any feature of any aspect of any other invention or embodiment described herein mutatis mutandis.

Specific embodiments of the invention will now be described by way of example, with reference to the accompanying drawings, in which:

FIGS. 1 and 2 are schematic representations of a wellbore being drilled; and

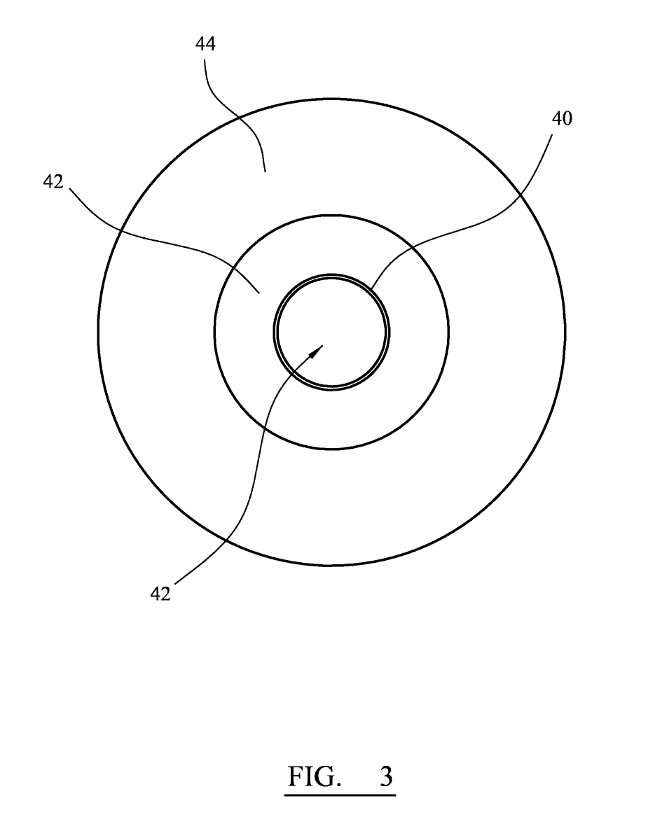

FIG. 3 is a schematic plan view illustrating the state of the near wellbore after treatment.

In the figures, the same or similar parts are annotated with the same reference numerals.

A 0.5 wt % solution of a selected polyvinylalcohol is prepared. The polyvinylalcohol comprises A 87-89 mole % hydrolysed polyvinylalcohol, wherein the viscosity of a 4 wt % aqueous solution at 20° C. is 3-3.7 cP which corresponds to a weight average molecular weight of about 20,000.

The polyvinylalcohol solution is used as an additive for water-based mud (WBM) drilling fluid or for drill-in fluids.

The most basic WBM contains water, clays and water soluble salts. The clays are usually a combination of native clays that are incorporated into the fluid as rock is drilled, or specific types of clay that are processed and sold as additives for the WBM system. The most common clay is bentonite, which when blended in the water can make the fluid thixotropic—i.e. while the fluid is being pumped it can be very thin and free-flowing, but when pumping is stopped, the static fluid builds a “gel” structure that resists flow and suspends solids. When an adequate pumping force is applied to “break the gel”, flow resumes and the fluid returns to its previously free-flowing state. In addition to clay, WBM's commonly contain density control agents such as barium sulfate, calcium carbonate or hematite. Various thickeners may be used to influence the viscosity of the fluid, eg. Xanthan gum, guar gum, glycol, carboxymethylcellulose, polyanionic cellulose (PAC), or starch. Deflocculants are used to regulate the viscosity of clay-based muds; these include anionic polyelectrolytes, such as acrylates, polyphosphates and lignosulphonates, or tannic acid derivatives.

A drill-in fluid is a special fluid designed for drilling through the reservoir section of a wellbore. It is a simple formulation designed to drill the reservoir zone successfully, to minimize damage and to maximize the production from exposed zones. A drill-in fluid may be a water-based brine containing only selected solids of appropriate particle sizes (salt crystals or calcium carbonate) and polymers. Only additives essential for filtration control and cuttings carrying are present in a drill-in fluid.

The polyvinylalcohol solution is dosed into the WBM or drilling fluid so that the concentration of the polyvinylalcohol in the aqueous phase of the fluid is in the range 0.2 to 2 wt %, preferably 0.3 to 1 wt %.

Once the WBM or drill-in fluid has been formulated with the polyvinylalcohol it may be used in a conventional manner. The benefits of the treatments are derived from the ability of the polyvinylalcohol to separate hydrocarbon moieties from surfaces. If a solution containing the polyvinylalcohol is placed in contact with a hydrocarbon moiety, itself in intimate contact with a second surface, the additive reacts with all surfaces spontaneously, or with minimal agitation, to separate the surfaces. In particular, oils are separated and encapsulated by a molecular layer of the additive. The outcome is that separate oil droplets are created, which slip and roll past surfaces to which they would ordinarily be bound. Oil droplets are therefore mobilized in environments where they would otherwise be immobile.

The first surface to be considered is that of another oil droplet, i.e. oil can slip against itself. The second surface is that of an adjacent metal object such as a pipe, the internals of a pump or a metal screen. A third surface is that of reservoir rock.

A first advantage of use of WBM or drill-in fluids modified as described is in the reduction of accretions which may lead to blockages of the borehole and/or increased drag on the drill-string, as illustrated in FIG. 2 described above. The use of polyvinylalcohol reduces or eliminates accretion by reducing the forces of adhesion between all relevant surfaces, including metal surfaces, hydrocarbon surfaces and the surfaces of contaminated drill cuttings. This leads to the ‘breaking up’ and mobilization of accreted blockages, or to the prevention of their formation in the first place. This improvement may be beneficial during the drilling of wells for flowable oils but may be particularly relevant during the drilling of horizontal wells for the SAGD production of non-flowable oils, where oil ladened sand may be produced extensively.

A second advantage of use of polyvinylalcohol-containing fluids is in the reduction of bit-balling, also illustrated in FIG. 2 as described above. Bit-balling can lead to increased pump pressures and reduced rate of penetration. Use of polyvinylalcohol will reduce or eliminate bit-balling by modifying the colloidal characteristics of clay in water to minimize adherence to the cutting surfaces of drill bits. This action will be enhanced if the aggregated clays contain hydrocarbons.

A third advantage of use of polyvinylalcohol-containing fluids relates to surface separation processes, for example using shale-shakers or the like. The use of polyvinylalcohol will reduce or minimize blockages in shale shakers by reducing the forces of adhesion between metal surfaces and the agglomerated solids described above, thereby, ‘breaking up’ and mobilizing blocking material or preventing it from forming in the first place. As a consequence, the level of residual hydrocarbon on the separated solids will be reduced.

A fourth advantage of use of polyvinylalcohol-containing fluids relates to the placement of liners in horizontal wellbore sections. The term “liner” is intended to encompass any metal, plastic or ceramic tube placed into the wellbore. It includes casing wellbore casing, liners, slotted liners, wire wrap screens, mesh screens gravel pack, tubing, coiled tubing or jointed tubing. The use of polyvinylalcohol additive in the drilling fluid may assist in the mobilization of wellbore debris, and the general reduction of friction, thus reducing the resistance to the placement of liners. This benefit has much in common with the mitigation of the accretion process described previously.

A particular significant advantage of use of polyvinylalcohol-containing fluids relates to improvement in the mobility of near wellbore fluids. The productivity of a drilled borehole can be conceptualized in terms of the radial flow of incompressible oil, or reservoir fluid, into the wellbore from the reservoir. In essence, the rate at which oil flows into the wellbore is regulated by the natural permeability of the reservoir rock and the difference in pressure between a point at the wellbore and a hypothetical reservoir pressure, often called the far field pressure. Elementary physics, based on Darcy's equations for radial flow, shows that the oil flow rate is extremely sensitive to the permeability of the rock, in particular to the permeability of the reservoir within a few inches of the wellbore. If the permeability of this region close to the wellbore is altered, the rate of fluid flow into the wellbore can be modified dramatically.

The natural permeability of a reservoir is a phenomenological measure of resistance to fluid flow, which is dependent on the interfacial chemistry of the rock and the interfacial chemistry of the reservoir fluids. Aqueous fluid comprising polyvinylalcohol will leak off during drilling, in particular during spurt loss, and this will increase the permeability of the region of reservoir close to the wellbore, thus increasing the rate of oil flow to the reservoir. This increase in permeability is a consequence of the property of the polyvinylalcohol to enhance the ability of the reservoir hydrocarbon to ‘slip’ along the internal surfaces of the porous rock, as illustrated in FIG. 3, wherein borehole 40 is surrounded by an altered zone 42 of increased permeability within a region of natural unaltered reservoir 44. Oil flows into the borehole 40 as illustrated by arrow 42. The increased permeability may be temporary, but may exist long enough to create permanent and highly conducting flow paths to the wellbore.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of drilling a bore hole in a subterranean formation, the method comprising the step of contacting a drill bit used in the drilling with a drilling fluid comprising a first polymeric material which includes —O— moieties pendent from a polymeric backbone.

2. A method according to claim 1, wherein said first polymeric material includes a moiety 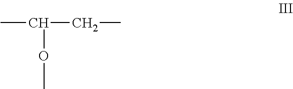
wherein said moiety III is part of a repeat unit.

3. A method according to claim 1, wherein at least 95 mole % of said first polymeric material comprises repeat units which comprise moieties III.

4. A method according to claim 1, wherein the free bond to the oxygen atom in the —O— moiety pendent from the polymeric backbone of said first polymeric material is bonded to a group R¹⁰, wherein R¹⁰ is selected from a hydrogen atom and an alkylcarbonyl group.

5. A method according to claim 1, wherein said first polymeric material includes a multiplicity of hydroxyl groups pendent from said polymeric backbone and a multiplicity of acetate groups pendent from the polymeric backbone.

6. A polymeric material according to claim 1, wherein the ratio of the number of acetate groups to the number of hydroxyl groups in said first polymeric material is in the range 0.06 to 0.3.

7. A method according to claim 1, wherein at least 70% of the free bonds to the oxygen atoms in —O— moieties pendent from the polymeric backbone in said first polymeric material are of formula —O—R¹⁰ wherein each group —OR¹⁰ is selected from hydroxyl and acetate.

8. A method according to claim 1, wherein said polymeric material comprises 60 to 99 mole % of vinylalcohol repeat units.

9. A method according to claim 1, wherein the sum of the mole % of vinylalcohol and vinylacetate repeat units in said first polymeric material is at least 80 mole %.

10. A method according to claim 1, wherein said first polymeric material comprises 70-95 mole % hydrolysed polyvinylalcohol.

11. A method according to claim 1, wherein said first polymeric material has a weight average molecular weight in the range 5,000 to 50,000.

12. A method according to claim 1, which includes a step prior to the step of contacting said drill bit with drilling fluid of selecting said first polymeric material and contacting said first polymeric material with a precursor of said drilling fluid thereby to prepare said drilling fluid, wherein said precursor of said drilling fluid is a conventional drilling fluid.

13. A method according to claim 12, wherein said first polymeric material selected comprises a solid which is contacted with said precursor of said drilling fluid.

14. A method according to claim 1, wherein said drilling fluid includes at least 0.1 wt % and less than 1.5 wt % of said first polymeric material.

15. A method according to claim 1, wherein the ratio of the wt % of first polymeric material to the wt % of water in the drilling fluid is at least 0.001 and is less than 0.003.

16. A method according to claim 1, wherein said drilling fluid includes at least 70 wt % water and less than 95 wt % water.

17. A method according to claim 1, wherein said drilling fluid includes at least 50 wt % water and said first polymeric material which comprises 85 to 91 mole % hydrolyzed polyvinylalcohol having a Mw in the range 5,000 to 30,000, wherein the ratio of the wt % of first polymeric material to the wt % of water in the drilling fluid is at least 0.002 and less than 0.02.

18. A method according to claim 1, wherein the ratio of the concentration of first polymeric material injected into the bore hole to the concentration in fluid returned to the surface is greater than 1 and is less than 5.

19. A method according to claim 1, wherein said method comprises drilling a bore hole which penetrates an oil reservoir which comprise crude oil having an API gravity of less than 45°.

20. A method according to claim 1, which comprises drilling a deviated or especially a horizontal well for use in, for example, a Steam Assisted Gravity Drain (SAGD) process.

21. A method according to claim 1, wherein said subterranean formation defines a reservoir with a permeability in the range 0.5-10 Darcy.

22. A method of preparing a drilling fluid as described according to claim 1, the method comprising selecting a first polymeric material according to claim 1, and contacting said first polymeric material with a precursor of said drilling fluid thereby to prepare said drilling fluid.

23. A method of preparing a pre-used drilling fluid for re-use, the method comprising:
(a) selecting a pre-used drilling fluid which has already been used in drilling a bore in a method according to claim 1, wherein said pre-used fluid includes a first polymeric material;
(b) separating undesirable components from the pre-used drilling fluid to provide a cleaned drilling fluid;
(c) contacting the cleaned drilling fluid with said first polymeric material to increase the concentration of said first polymeric material in said cleaned drilling fluid in order to prepare a cleaned drilling fluid for re-use.

24. A method according to claim 1 which includes reducing the susceptibility of a wellbore to blockages caused by penetration of components of drilling fluid thereinto during drilling and/or for reducing accumulation of accretions in a passage via which used drilling fluid is returned to the surface during drilling of a wellbore and/or for reducing bit-balling and/or for facilitating separation of undesirable insoluble solids from a drilling fluid returned to the surface, the method comprising using a drilling fluid comprising a first polymeric material as described in claim 1.
